(19) United States
(12) Patent Application Publication
(10) Pub. No.: US 2013/0101866 A1
(43) Pub. Date: Apr. 25, 2013

(54) COMBINED WELDING/SOLDERING PROCESS FOR A STRUCTURAL PART AND STRUCTURAL PART

(71) Applicant: Sebastian Piegert, Berlin (DE)

(72) Inventor: Sebastian Piegert, Berlin (DE)

(21) Appl. No.: 13/655,876

(22) Filed: Oct. 19, 2012

(30) Foreign Application Priority Data
Oct. 21, 2011 (EP) 11186178.7

(51) Int. Cl. B32B 15/01; B23K 31/02

(52) U.S. Cl. 428/615; 228/256

(57) ABSTRACT

A combined welding and soldering process for a structural part and a structural part are provided. The combined welding and soldering process can achieve joints which are stable at high temperatures between the components. All contacts between the components can be joined to one another optionally in accordance with their loading.

### CROSS REFERENCE TO RELATED APPLICATIONS

This application claims priority of European application No. 11186178.7 filed Oct. 21, 2011, which is incorporated by reference herein in its entirety.

### FIELD OF INVENTION

The application relates to a welding and/or soldering process for producing a structural part and to a structural part.

### BACKGROUND OF INVENTION

Soldering or welding processes for joining structural parts are prior art, soldered joints usually having a lower temperature resistance compared to the base material and also compared to welded joints on account of the relatively low melting temperature of the solder. However, soldered joints can also be produced at sites which are difficult to access. The welding process can only be carried out at sites which are easily accessed.

### SUMMARY OF INVENTION

It is an object of the application to produce a structural part from components which are joined to one another in an optimum manner.

The object is achieved by a process and a structural part as claimed in the independent claims. The dependent claims list further measures which can be combined with one another, as desired, in order to achieve further features.

### BRIEF DESCRIPTION OF THE DRAWINGS

In the drawings:

FIGS. 1-4 show steps of the process according to the application,

FIG. 5 shows a turbine blade or vane,

FIG. 6 shows a gas turbine,

FIG. 7 shows a list of superalloys.

### DETAILED DESCRIPTION OF INVENTION

The figures and the description represent merely embodiments of the application.

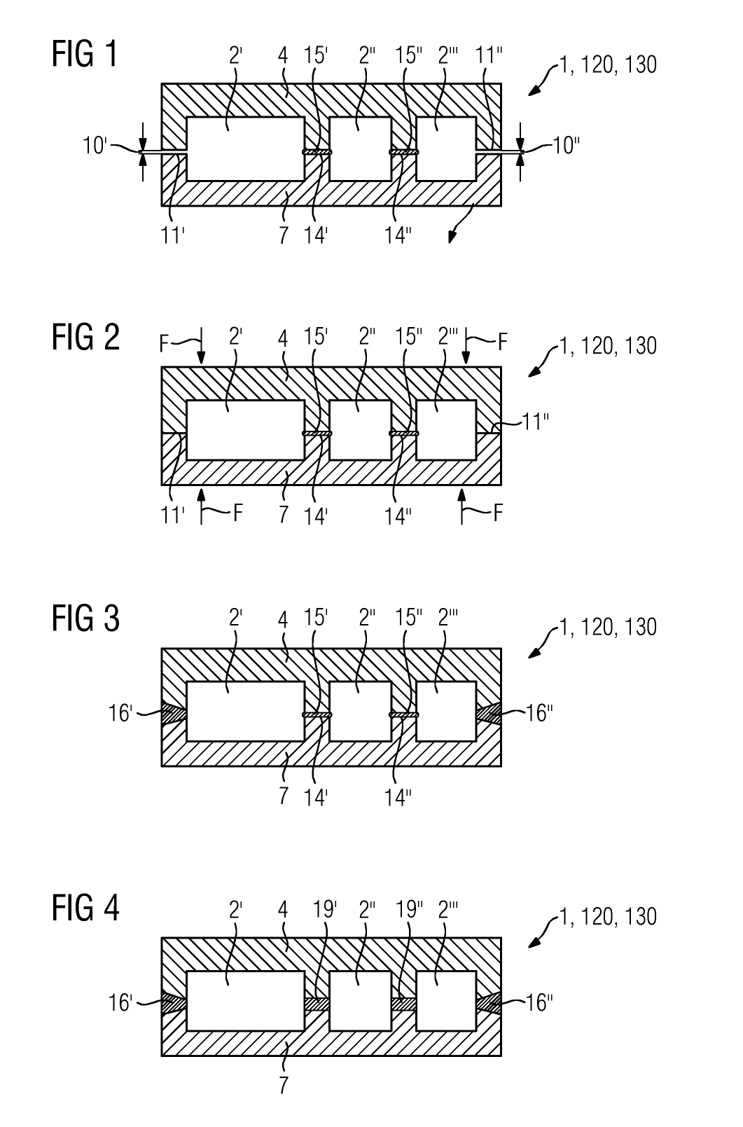

FIG. 1 shows a structural part 1, 120, 130 which is to be produced and is to be joined together from at least two, such as from only two, components 4, 7.

The structural part 1, 120, 130 to be produced is a hollow structural part 1, 120, 130 having at least one hollow space 2′, 2″, 2′″ and has outer contact sites 11′, 11″, . . . accessible from the outside, but also on the inside inner contact sites 14′, 14″, . . . which are not accessible from the outside, at which components 4, 7 are moved into contact resting on one another. A solder 15′, 15″, . . . is applied to the inner contact sites 14′, 14″, . . . .

In this case, a spacing 10′, 10″, . . . is to be provided in the region of the outer contact sites 11′, 11″, . . . between the components 4, 7 when the solder 15′, 15″, . . . is applied.

The components 4, 7 are then pressed together (F) such that the spacing 10′, 10″, . . . as per FIG. 1 is no longer present or is/becomes considerably smaller (FIG. 2). While maintaining a force F, a welded joint or weld seam 16′, 16″ is produced at the outer contact sites (FIG. 3) such that the components 4, 7 are already joined to one another.

The welded joint 16′, 16″ can also be a continuous weld seam which, such as, runs around the entire structural part 1, 120, 130.

In the last step, as per FIG. 4, heat treatment is effected, such that only then a soldered joint 19′, 19″ is produced at the inner contact sites 14′, 14″, . . . by the already present solder 15′, 15″, . . . . The components are joined to one another at many inner and outer contact sites 11′, 11″, 14′, 14″, . . . . The solders are high-melting solders based on Ni, Ni—Co, Pd or Au or Au—Pd.

The solder can be applied both in the form of solder paste and as a film or presintered solder sheet. Depending on the use of the structural part 1, 120, 130, it has to be compatible with the base material of the components 4, 7.

The inner soldered joints 19′, 19″, . . . generally experience, in the case of turbine components 120, 130, a lower temperature than the outer regions, where the welded joints 16′, 16″, . . . are located, and a sufficient strength of equal magnitude is provided universally.

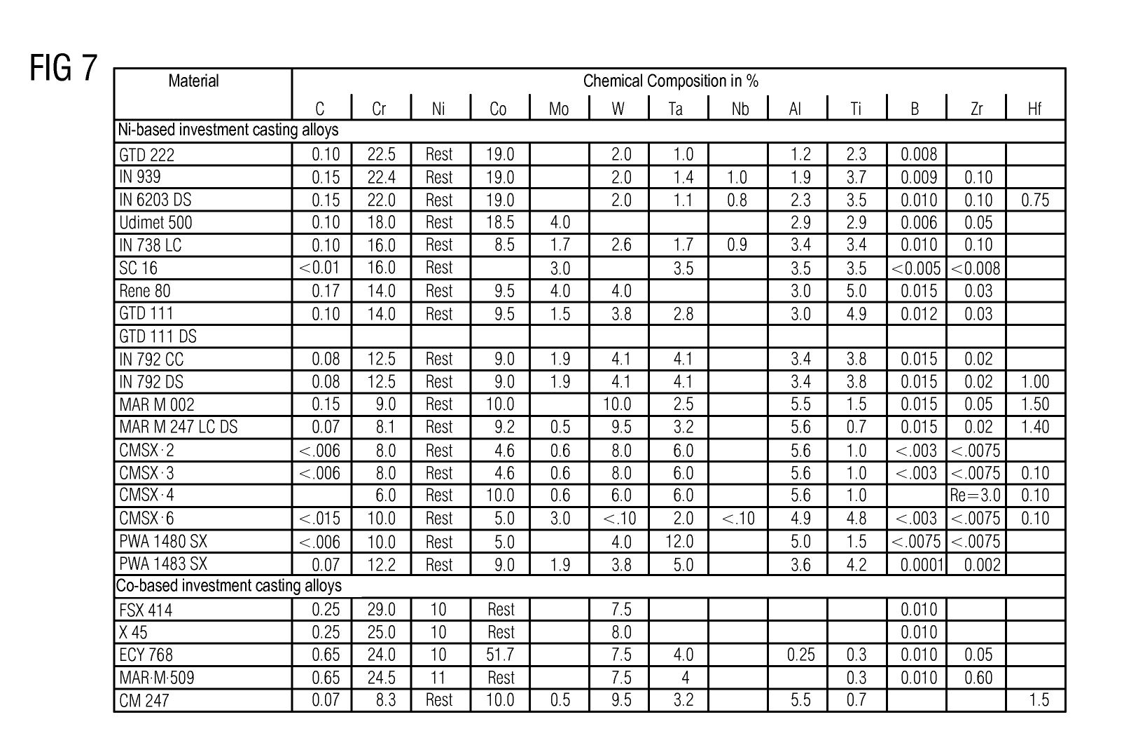

The materials for the components 4, 7 are nickel-based or cobalt-based superalloys as per FIG. 7.

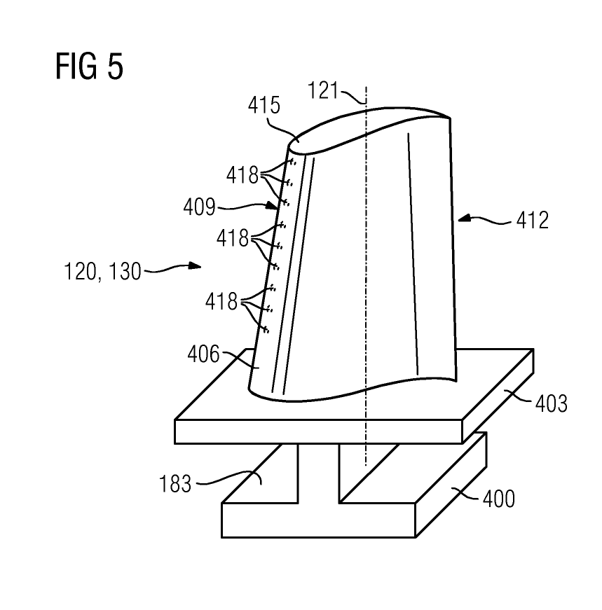

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, such as superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949. The blade or vane 120, 130 may in this case be produced by a casting process, by directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1. The density is 95% of the theoretical density. A protective aluminum oxide layer (TGO=thermally grown oxide layer) is formed on the MCrAlX layer (as an intermediate layer or as the outermost layer).

The layer has a composition Co-30Ni-28Cr-8Al-0.6Y-0.75Si or Co-28Ni-24Cr-10Al-0.6Y. In addition to these cobalt-based protective coatings, it is also to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is the outermost layer, to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is more porous than the MCrAlX layer.

Refurbishment means that after they have been used, protective layers may have to be removed from structural parts 120, 130 (e.g. by sand blasting). Then, the corrosion and/or oxidation layers and products are removed. If appropriate, cracks in the structural part 120, 130 are also repaired. This is followed by recoating of the structural part 120, 130, after which the structural part 120, 130 can be reused.

The blade or vane 120, 130 may be hollow or solid in form. If the blade or vane 120, 130 is to be cooled, it is hollow and may also have film-cooling holes 418 (indicated by dashed lines).

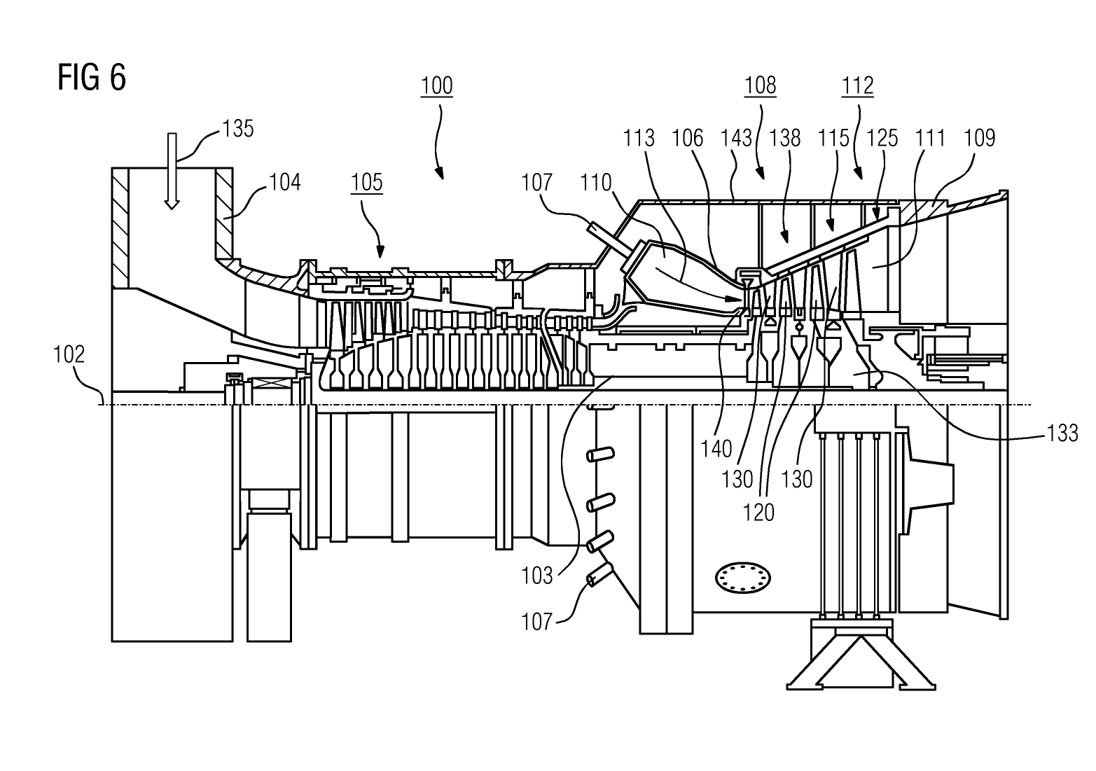

FIG. 6 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, such as an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the structural parts which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses. To be able to withstand the temperatures which prevail there, they may be cooled by a coolant.

Substrates of the structural parts may likewise have a directional structure, i.e. they are in single-crystal form (SX structure) or have only longitudinally oriented grains (DS structure).

By way of example, iron-based, nickel-based or cobalt-based superalloys are used as material for the structural parts, such as for the turbine blade or vane 120, 130 and structural parts of the combustion chamber 110. Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1. A process for joining at least two components to form a structural part, comprising:
applying a solder to inner contact sites of at least one of the at least two components;
joining outer contact sites of the at least two components to one another by welded joints; and
performing a heat treatment to the structural part so that only the solder fuses onto the inner contact sites and the at least two components are joined to one another at the inner contact sites.

2. The process as claimed in claim 1, wherein a hollow structural part is produced.

3. The process as claimed in claim 1, wherein a space exists between the at least two components at the outer contact sites when the solder has been applied to the inner contact sites.

4. The process as claimed in claim 1, wherein a force acts on the at least two components when the at least two components are welded to one another.

5. A structural part, comprising:
at least two components jointed to one another by a process as claimed in claim 1,
wherein the structural part has inner soldering sites and outer welded joints on the at least two components.
